(19) United States
(12) Patent Application Publication
(10) Pub. No.: US 2023/0317026 A1
(43) Pub. Date: Oct. 5, 2023

(54) DISPLAY DEVICE

(71) Applicant: Japan Display Inc., Tokyo (JP)

(72) Inventor: Daijiro TAKANO, Tokyo (JP)

(21) Appl. No.: 18/129,144

(22) Filed: Mar. 31, 2023

(30) Foreign Application Priority Data
Mar. 31, 2022 (JP) 2022-059821

(51) Int. Cl. G09G 3/36

(52) U.S. Cl. CPC G09G 3/3677; G09G 3/3696; G09G 2320/0247; G09G 2360/148

(57) ABSTRACT

According to one embodiment, a display device includes a display panel and a processing unit. The display panel includes a first substrate, a second substrate and a liquid crystal layer. The first substrate includes a plurality of pixel electrodes, a plurality of switching elements, a common electrode and an optical sensor. The optical sensor outputs a detection signal corresponding to an amount of light coming from the liquid crystal layer side. The processing unit adjusts a common voltage supplied to the common electrode, based on a first detection signal output from the optical sensor when the display panel is in a positive polarity state, and a second detection signal output from the optical sensor when the display panel is in a negative polarity state.

### CROSS-REFERENCE TO RELATED APPLICATIONS

This application is based upon and claims the benefit of priority from Japanese Patent Application No. 2022-059821, filed Mar. 31, 2022, the entire contents of which are incorporated herein by reference.

### FIELD

Embodiments described herein relate generally to a display device.

### BACKGROUND

Active matrix display devices in which switching elements are arranged for each pixel can apply a necessary voltage only to a desired pixel and thereby significantly reduce crosstalk as compared to simple matrix display devices. However, active matrix display devices have a problem that flicker caused by on and off operations of switching elements occurs.

### BRIEF DESCRIPTION OF THE DRAWINGS

FIG. 1 is a time chart showing time variation of a scanning signal potential, a pixel signal potential, a pixel electrode potential, and a common electrode potential.

FIG. 2 is a cross-sectional view schematically showing a display device according to an embodiment.

FIG. 3 is a plan view schematically showing the display device according to the embodiment.

FIG. 4 is an equivalent circuit diagram showing a sensor and a sensor circuit according to the embodiment.

FIG. 5 is a chart illustrating an operation example of the sensor and the sensor circuit according to the embodiment.

FIG. 6 is a cross-sectional view showing an example of a schematic configuration of the first substrate according to the embodiment.

FIG. 7 is a plan view schematically showing several elements of the first substrate according to the embodiment.

FIG. 8 is a diagram illustrating an overview of operations of AFE-IC according to the embodiment.

FIG. 9 is a diagram showing a configuration example of the AFE-IC according to the embodiment.

FIG. 10 is a flowchart showing a procedure example of a common voltage adjustment process according to the embodiment.

FIG. 11 is a diagram showing the configuration example of the AFE-IC according to the embodiment.

FIG. 12 is a flowchart showing a procedure example of the common voltage adjustment process according to the embodiment.

### DETAILED DESCRIPTION

In general, according to one embodiment, a display device includes a display panel and a processing unit. The display panel includes a first substrate, a second substrate opposed to the first substrate, and a liquid crystal layer located between the first substrate and the second substrate. The processing unit is mounted on the display panel. The first substrate includes a plurality of pixel electrodes, a plurality of switching elements, a common electrode and an optical sensor. The plurality of switching elements are provided to correspond to the plurality of pixel electrodes, respectively. The common electrode is opposed to the plurality of pixel electrodes. The optical sensor outputs a detection signal corresponding to an amount of light coming from the liquid crystal layer side. The processing unit adjusts a common voltage supplied to the common electrode, based on a first detection signal output from the optical sensor when the display panel is in a positive polarity state, and a second detection signal output from the optical sensor when the display panel is in a negative polarity state.

Embodiments will be described hereinafter with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, an X-axis, a Y-axis and a Z-axis orthogonal to each other are described in the drawings to facilitate understanding as needed. A direction along the X-axis is referred to as an X-direction or a first direction, a direction along the Y-axis is referred to as a Y-direction or a second direction, and a direction along the Z-axis is referred to as a Z-direction or a third direction. A plane defined by the X-axis and the Y-axis is referred to as an X-Y plane, and a plane defined by the X-axis and Z-axis is referred to as an X-Z plane. Viewing the X-Y plane is referred to as planar view.

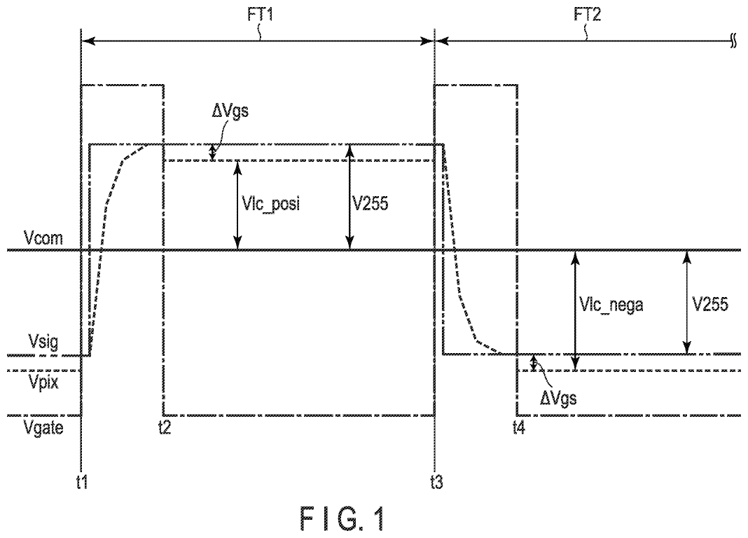

First, flicker (screen flicker) that occurs on an active matrix liquid crystal display panel with switching elements arranged in each pixel will be described with reference to FIG. 1.

FIG. 1 is a time chart showing the time variation of a scanning signal potential Vgate, a pixel signal (video signal) potential Vsig, a pixel electrode potential Vpix, and a common electrode potential Vcom. A one-dot chain line in FIG. 1 corresponds to the scanning signal potential Vgate, a two-dot chain line in FIG. 1 corresponds to the pixel signal potential Vsig, a broken line in FIG. 1 corresponds to the pixel electrode potential Vpix, and a solid line in FIG. 1 corresponds to the common electrode potential Vcom. In FIG. 1, it is assumed that a frame-inversion drive scheme of inverting pixel signals to be written to all pixels with the same polarity at once for each frame is adopted as a drive scheme of the liquid crystal display panel. In addition, in FIG. 1, it is assumed that the common electrode potential Vcom is constant (i.e., the common DC). Furthermore, in FIG. 1, it is assumed that a pixel signal to display white color (i.e., a pixel signal of a pixel value 255) is written to a pixel, and a potential of the pixel signal is denoted as V255.

FIG. 1 shows an example where a positive polarity pixel signal is supplied to a pixel in a first frame period FT1 and a negative polarity pixel signal is supplied to a pixel in a second frame period FT2 following the first frame period FT1. Therefore, the pixel electrode potential Vpix is a positive polarity potential in the first frame period FT1 and a negative polarity potential in the second frame period FT2 with respect to the common electrode potential Vcom.

As shown in FIG. 1, a positive polarity pixel signal is supplied to the pixel electrode when the first frame period FT1 starts at time t1, a scanning signal is supplied to a gate electrode of the switching element, and the switching element is turned on. According to this, the pixel electrode potential Vpix becomes a positive polarity potential with respect to the common electrode potential Vcom, and becomes Vcom+V255. At time t2, when the supply of the scanning signal to the gate electrode of the switching element is terminated and the switching element is turned off, the pixel electrode potential Vpix decreases by a field-through voltage ΔVgs caused by a parasitic capacitance and becomes Vcom+V255−ΔVgs. A voltage Vlc_posi corresponding to a potential difference between the pixel electrode potential Vpix and the common electrode potential Vcom is applied to the liquid crystal layer, and its value becomes V255−ΔVgs. Since the pixel signal potential Vsig is fixed to the potential of the pixel signal supplied via the signal line, potential drop does not occur and the potential remains constant.

As shown in FIG. 1, when the second frame period FT2 starts at time t3, a scanning signal is supplied to the gate electrode of the switching element, the switching element is turned on, and the negative polarity pixel signal is supplied to the pixel electrode. According to this, the pixel electrode potential Vpix becomes a negative polarity potential with respect to the common electrode potential Vcom and becomes Vcom−V255. At time t4, when the supply of the scanning signal to the gate electrode of the switching element is terminated and the switching element is turned off, the pixel electrode potential Vpix decreases by the field-through voltage ΔVgs which is caused by the parasitic capacitance, and becomes Vcom−V255−ΔVgs. In the second frame period FT2, similarly to the first frame period FT1, a voltage Vlc_nega corresponding to the potential difference between the pixel electrode potential Vpix and the common electrode potential Vcom is applied to the liquid crystal layer, and its value becomes V255+ΔVgs. In this case, too, since the pixel signal potential Vsig is fixed to the potential of the pixel signal supplied via the signal line, potential drop does not occur and the potential remains constant.

As described above, in the first frame period FT1 and the second frame period FT2, the pixel electrode potential Vpix is asymmetric between positive polarity and negative polarity with respect to the common electrode potential Vcom, and screen flicker referred to as flicker occurs.

For this reason, in general, when the liquid crystal display panel is assembled, a flicker component is measured using a flicker meter or the like, and the common voltage Vcom is adjusted to minimize the flicker component. However, such adjustment requires changing parameters and adjusting the common voltage Vcom applied to the common electrode until the flicker component is minimized, resulting in work costs and tact loss. In addition, flicker also occurs due to changes in the characteristics of the switching elements which are caused by aging and operating temperatures. Therefore, even if the common voltage Vcom is adjusted when the liquid crystal display panel is assembled, the flicker which occurs subsequently cannot be suppressed.

In the present specification, a display device capable of optimizing the common voltage Vcom applied to the common electrode without the work costs and tact loss and capable of dealing with the flicker which occurs subsequently will be described.

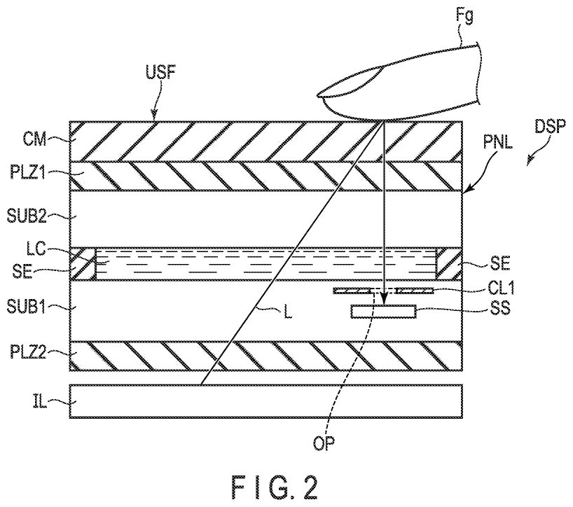

FIG. 2 is a cross-sectional view schematically showing the display device DSP according to the present embodiment. The display device DSP comprises a display panel PNL, a cover member CM, a first polarizer PLZ1, a second polarizer PLZ2, and an illumination device IL.

The display panel PNL is a liquid crystal panel, and comprises a first substrate SUB1, a second substrate SUB2 opposed to the first substrate SUB1, a sealant SE, and a liquid crystal layer LC. The liquid crystal layer LC is sealed between the first substrate SUB1 and the second substrate SUB2 by the sealant SE. The display panel PNL of the present embodiment is a transmissive display panel which displays images by selectively transmitting light from a back surface side of the first substrate SUB1 to an upper surface side of the second substrate SUB2.

The first substrate SUB1 comprises a sensor SS and a collimating layer CL1. The sensor SS is located between a main surface of the first substrate SUB1 and the collimating layer CL1. The main surface of the first substrate SUB1 is opposed to the second polarizer PLZ2. The collimating layer CL1 includes an opening OP which overlaps with the sensor SS. The collimating layer CL1 is formed of, for example, a metal material and has light-shielding properties. Such a collimating layer may be arranged in not only the first substrate SUB1, but may be further arranged in the second substrate SUB2.

The sealant SE bonds the first substrate SUB1 and the second substrate SUB2. A predetermined cell gap is formed between the first substrate SUB1 and the second substrate SUB2 by a spacer (not shown). The liquid crystal layer LC is buried in this cell gap.

The cover member CM is provided on the display panel PNL. For example, a glass substrate or a resin substrate can be used as the cover member CM. The cover member CM has an upper surface USF which an object to be detected by the sensor SS contacts. In the present embodiment, it is assumed that the upper surface USF of the cover member CM is parallel to the upper surface of the sensor SS. In the example of FIG. 2, a finger Fg which is an example of the object is in contact with the upper surface USF. The first polarizer PLZ1 is provided between the display panel PNL and the cover member CM.

The illumination device IL is provided under the display panel PNL and emits light L to the first substrate SUB1. The illumination device IL is, for example, a side-edge type backlight and comprises a plate-shaped light guide and a plurality of light sources that emit light to a side surface of the light guide. The second polarizer PLZ2 is provided between the display panel PNL and the illumination device IL.

Reflective light that is reflected by the finger Fg, of the light L, comes in the sensor SS through the opening OP formed in the collimating layer CL1. In other words, the reflective light that is reflected by the finger Fg is transmitted through the cover member CM, the first polarizer PLZ1, the second substrate SUB2, the liquid crystal layer LC, and a portion of the first substrate SUB1 which is located on an upper side than the sensor SS, before coming in the sensor SS.

The sensor SS outputs a detection signal corresponding to the incident light. For this reason, the sensor SS is referred to as an optical sensor in some cases. As described below, the display panel PNL comprises a plurality of sensors SS, and can detect unevenness on the surface of the finger Fg, i.e., fingerprint, based on the detection signal output from the sensors SS.

The sensor SS desirably detects the incident light parallel to the normal of the upper surface USF in order to obtain a more accurate detection signal. The collimating layer CL1 functions as a collimator which parallelizes the light coming in the sensor SS. In other words, the collimating layer CL1 blocks the light inclined to the normal of the upper surface USF (in other words, the light inclined to the normal of the upper surface of the sensor SS).

As described above, a function of a fingerprint sensor can be added to the display device DSP by mounting the sensor SS on the display device DSP. In addition, the sensor SS can also be used for the purpose of detecting biometric information, based on the light reflected inside the finger Fg, in addition to or instead of detection of the fingerprint. The biometric information is, for example, images of blood vessels such as veins, a pulse, a pulse wave, and the like. Alternatively, the sensor SS can also be used for the purpose of detecting an object, based on the light reflected by the object, in addition to or instead of detection of the fingerprint.

Furthermore, as described below in detail, the display device DSP can adjust the common voltage Vcom to minimize the flicker component, based on the detection signal output from the sensor SS.

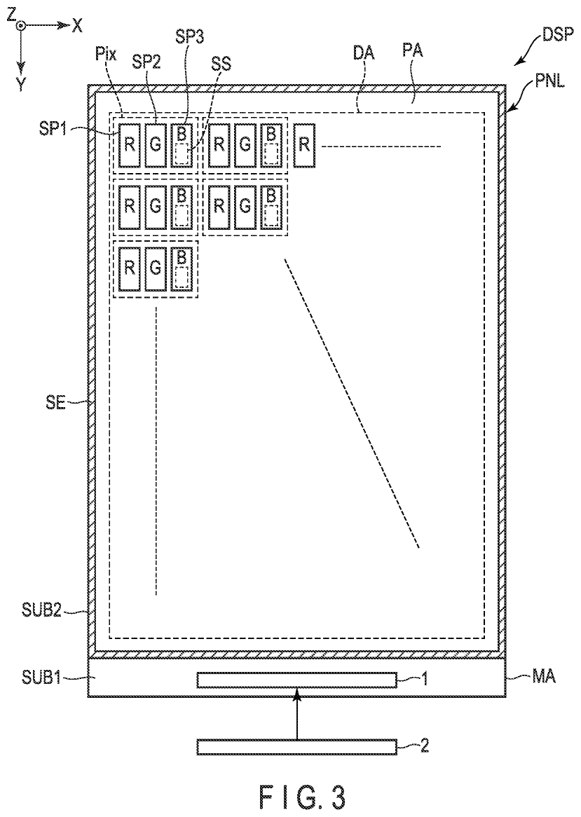

FIG. 3 is a plan view schematically showing the display device DSP according to the present embodiment. The display device DSP comprises the display panel PNL described above, an AFE-IC 1 mounted on the display panel PNL, and an MCU 2 provided outside the display panel PNL. The display panel PNL includes a display area DA on which images are displayed and a peripheral area PA surrounding the display area DA.

The first substrate SUB1 includes a mounting area MA that does not overlap with the second substrate SUB2. The sealant SE is located in the peripheral area PA. In FIG. 3, the area in which the sealant SE is arranged is represented by hatch lines. The display area DA is located inside the sealant SE. The display panel PNL comprises a plurality of pixels Pix arrayed in a matrix in the first direction X and the second direction Y, in the display area DA.

Each of the pixels Pix includes a sub-pixel SP1 that emits red (R) light, a sub-pixel SP2 that emits green (G) light, and a sub-pixel SP3 that emits blue (B) light. The pixel Pix may also include a sub-pixel emitting light of a color other than red, green and blue.

In the example of FIG. 3, one sensor SS is arranged in each pixel Pix. More specifically, one sensor SS is arranged for each sub-pixel SP3 emitting blue light included in each pixel Pix. In the entire display area DA, the sensors SS are arrayed in a matrix in the first direction X and the second direction Y.

The arrangement form of the sensor SS is not limited to the example in FIG. 3. For example, if the sensor SS is not used as a fingerprint sensor but used only for optimizing the common voltage Vcom, at least one sensor SS needs only to be arranged in any position.

The AFE-IC 1 has a function of adjusting the common voltage Vcom to minimize the flicker component, based on the detection signal output from sensor SS. The detailed configuration and functions of the AFE-IC 1 will be described below, and their detailed descriptions are omitted here. The MCU 2 generates a signal necessary for the AFE-IC 1 to adjust the common voltage Vcom. Since the detailed functions of the MCU 2 are also described below, their detailed descriptions are omitted here. The AFE-IC 1 is referred to as a processing unit in some cases. The MCU 2 is referred to as a controller in some cases.

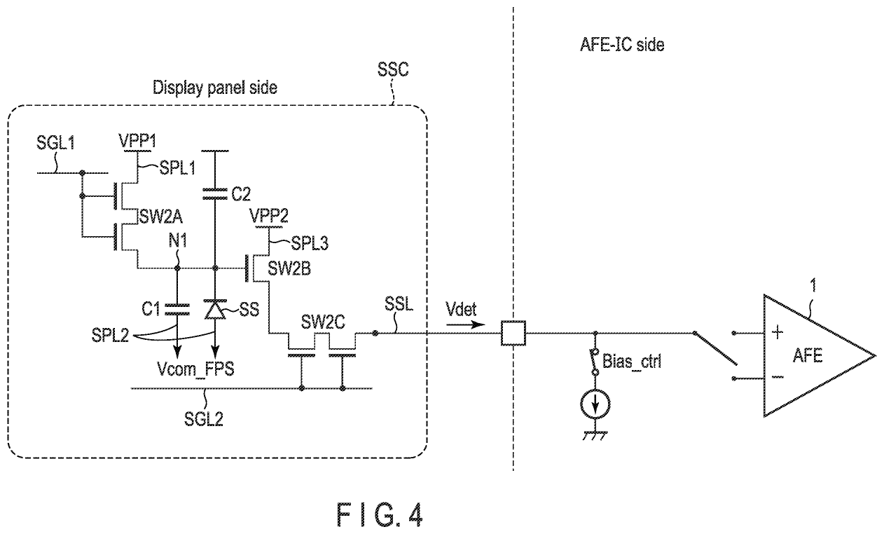

FIG. 4 is an equivalent circuit diagram showing the sensor SS and a sensor circuit SSC connected to the sensor SS. As shown in FIG. 4, a first sensor scanning line SGL1, a second sensor scanning line SGL2, a first sensor power line SPL1, a second sensor power line SPL2, a third sensor power line SPL3, a sensor signal line SSL, a switching element SW2A, a switching element SW2B, a switching element SW2C, a capacitor C1, and a capacitor C2 are provided in the sensor circuit SSC.

In the following descriptions, the first sensor scanning line SGL1 is referred to as a first scanning line SGL1, the second sensor scanning line SGL2 is referred to as a second scanning line SGL2, a first sensor power line SPL1 is referred to as a first power line SPL1, a second sensor power line SPL2 is referred to as a second power line SPL2, and the third sensor power line SPL3 is referred to as a third power line SPL3.

In addition, in FIG. 4, each of switching elements SW2A, SW2B, and SW2C is composed of n-type Thin Film Transistor (TFT), but the switching elements SW2A, SW2B, and SW2C may be composed of p-type TFT.

For the sensor SS, one electrode is connected to the second power line SPL2 and the other electrode is connected to a node N1. The node N1 is connected to a drain electrode of the switching element SW2A and a gate electrode of the switching element SW2B. One electrode of the sensor SS is supplied with a second potential Vcom_FPS through a second power line SPL2. The second potential Vcom_FPS may be referred to as a sensor reference potential. When light comes in the sensor SS, a signal (electric charge) corresponding to the amount of the incident light is output from sensor SS and stored in the capacitor C1. The capacitance stored in the capacitor C2 is a parasitic capacitance loaded on the capacitance stored in the capacitor C1.

For the switching element SW2A, a gate electrode is connected to the first scanning line SGL1, a source electrode is connected to the first power line SPL1, and a drain electrode is connected to the node N1. When the switching element SW2A is turned on in response to the scanning signal supplied from the first scanning line SGL1, the potential of the node N1 is reset to a first potential VPP1 supplied through the first power line SPL1. The first potential VPP1 may be referred to as a reset potential. The second potential Vcom_FPS indicates a value lower than the first potential VPP1, and the sensor SS is driven by reverse bias.

For the switching element SW2B, a gate electrode is connected to the node N1, a source electrode is connected to a third power line SPL3 at a third potential VPP2, and a drain electrode is connected to a source electrode of the switching element SW2C. The gate electrode of the switching element SW2B is supplied with the signal output from the sensor SS. According to this, the switching element SW2B outputs a voltage signal corresponding to the signal output from the sensor SS to the switching element SW2C.

For the switching element SW2C, a gate electrode is connected to the second scanning line SGL2, the source electrode is connected to the drain electrode of the switching element SW2B, and a drain electrode is connected to the sensor signal line SSL. When the switching element SW2C is turned on in response to the scanning signal supplied from the second scanning line SGL2, the voltage signal output from the switching element SW2B is output to the sensor signal line SSL as a detection signal Vdet.

In FIG. 4, the switching elements SW2A and SW2C have a double-gate structure, but the switching elements SW2A and SW2C may have a single-gate structure or a multi-gate structure.

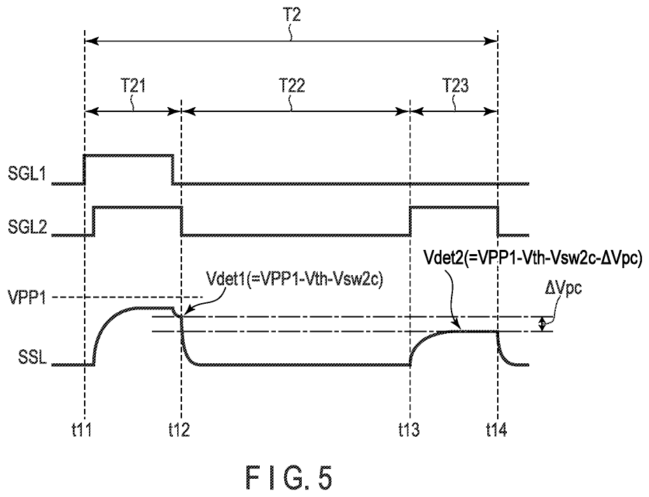

FIG. 5 is a chart illustrating an example of operations of the sensor SS and the sensor circuit SSC according to the present embodiment. The sensor SS executes capturing (detection operation) of a fingerprint in a fingerprint capturing period T2 shown in FIG. 5. As shown in FIG. 5, the fingerprint capturing period T2 is mainly composed of three frames and includes a reset period T21, an exposure period T22, and a read period T23. Although not shown here, one electrode of the sensor SS is supplied with the second potential Vcom_FPS in the reset period T21, the exposure period T22, and the read period T23.

The reset period T21 is a period for resetting the potential of the node N1. At time t11, when the reset period T21 is started and the switching element SW2A turns on in response to the scanning signal supplied from the first scanning line SGL1, the potential of the node N1 is reset to the first potential VPP1 supplied through the first power line SPL1. When the switching element SW2C is turned on in response to the scanning signal supplied through the second scanning line SGL2, a detection signal Vdet1 is output to the sensor signal line SSL. The potential of the detection signal Vdet1 output during the reset period T21 is VPP1−Vth−Vsw2c. Vth refers to a threshold voltage of the switching element SW2B which functions as a source follower, and Vsw2c refers to a voltage drop which occurs due to the on-resistance of the switching element SW2C.

The exposure period T22 is a period in which the light reflected by the finger comes in the sensor SS. At time t12, when the reset period T21 is terminated and the exposure period T22 is started, the switching elements SW2A and SW2C are turned off. Although illustration is omitted here, the potential of the node N1 decreases according to the amount of the light coming in the sensor SS (i.e., the light reflected by the finger) and becomes VPP1−ΔVpc. ΔVpc refers to the voltage drop which occurs by the light coming in the sensor SS.

At time t13, when the exposure period T22 is terminated and the read period T23 is started, the switching element SW2C is turned on according to the scanning signal supplied from the second scanning line SGL2, and a detection signal Vdet2 is output to the sensor signal line SSL. The potential of the detection signal Vdet2 output during the read period T23 is VPP1−Vth−Vsw2c−ΔVpc. In other words, the potential of the detection signal Vdet2 output during the read period T23 is lower by ΔVpc than the potential of the detection signal Vdet1 output during the reset period T21. At time t14, the read period T23 is terminated.

The AFE-IC 1 can compare the potential of the detection signal Vdet1 output during the reset period T21 with the potential of the detection signal Vdet2 output during the read period T23, and can detect the light coming in the sensor SS, based on the difference (i.e., ΔVpc). In FIG. 5, an example of operations of one sensor SS and the sensor circuit SSC is shown, but all sensors SS and sensor circuits SSC can be operated in the same manner. The AFE-IC 1 can detect unevenness on the finger surface (fingerprint), blood vessel images (vein patterns), and the like by analyzing the in-plane distribution of the above-mentioned difference obtained from all the sensors SS.

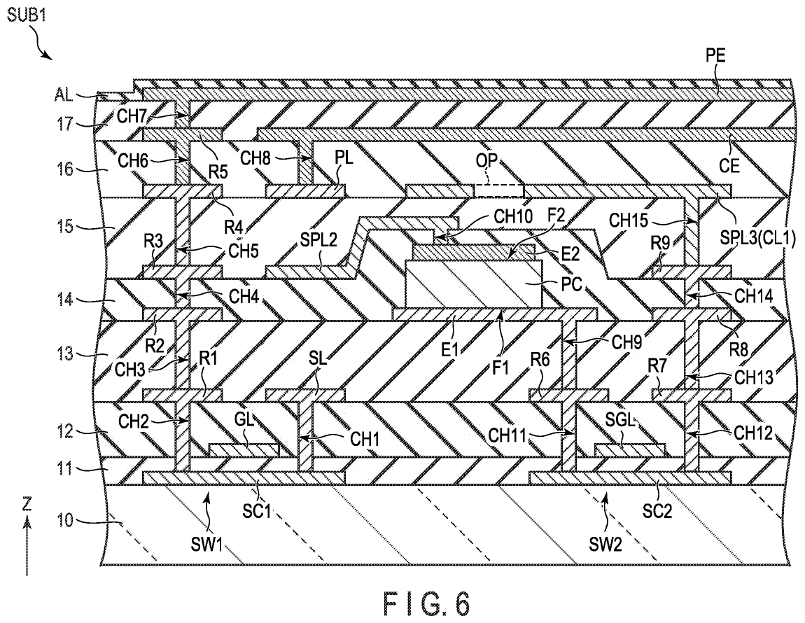

FIG. 6 is a cross-sectional view showing the schematic configuration example of the first substrate SUB1. The first substrate SUB1 comprises a transparent first base material 10, insulating layers 11, 12, 13, 14, 15, 16, and 17, and an alignment film AL.

The first base material 10 is, for example, a glass substrate or a resin substrate. The insulating layers 11, 12, 14, and 17 are formed of an inorganic material. The insulating layers 13, 15, and 16 are formed of an organic material. The insulating layers 11, 12, 13, 14, 15, 16, and 17 and the alignment film AL are stacked in this order in the third direction Z, above the first substrate 10.

The first substrate SUB1 comprises a signal line SL, a scanning line GL, a switching element SW1, a pixel electrode PE, a common electrode CE, relay electrodes R1, R2, R3, R4, and R5, and a power line PL, as elements related to image display. The pixel electrode PE and the switching element SW1 are provided for each of the sub-pixels SP1, SP2, and SP3. For example, the common electrode CE is provided over the sub-pixels SP1, SP2, and SP3.

The switching element SW1 includes a semiconductor layer SC1. The semiconductor layer SC1 is arranged between the first base material 10 and the insulating layer 11. The scanning line GL is arranged between the insulating layers 11 and 12 and is opposed to the semiconductor layer SC1. The scanning line GL may be arranged not between the insulating layers 11 and 12, but in the other layer. The signal line SL is arranged between the insulating layers 12 and 13 and is in contact with the semiconductor layer SC1 through a contact hole CH1 penetrating the insulating layers 11 and 12.

The relay electrode R1 is arranged between the insulating layers 12 and 13, i.e., in the same layer as the signal line SL, and is in contact with the semiconductor layer SC1 through a contact hole CH2 penetrating the insulating layers 11 and 12. The relay electrode R2 is arranged between the insulating layers 13 and 14 and is contact with the relay electrode R1 through a contact hole CH3 penetrating the insulating layer 13. The relay electrode R3 is arranged between the insulating layers 14 and 15 and is contact with the relay electrode R2 through a contact hole CH4 penetrating the insulating layer 14. The relay electrode R4 is arranged between the insulating layers 15 and 16 and is contact with the relay electrode R3 through a contact hole CH5 penetrating the insulating layer 15. The relay electrode R5 is arranged between the insulating layers 16 and 17 and is contact with the relay electrode R4 through a contact hole CH6 penetrating the insulating layer 16.

The pixel electrode PE is arranged between the insulating layer 17 and the alignment film AL and is in contact with the relay electrode R5 through a contact hole CH7 penetrating the insulating layer 17. The power line PL is arranged between the insulating layers 15 and 16, i.e., in the same layer as the relay electrode R4. The common electrode CE is arranged between the insulating layers 16 and 17, i.e., in the same layer as the relay electrode R5 and is in contact with the power line PL through a contact hole CH8 penetrating the insulating layer 16.

A common voltage Vcom is supplied to the power line PL. The common voltage Vcom is supplied to the common electrode CE. A pixel signal (video signal) is supplied to the signal line SL and a scanning signal is supplied to the scanning line GL. When the scanning signal is supplied to the scanning line GL, the video signal of the signal line SL is supplied to the pixel electrode PE through the semiconductor layer SC1 and the relay electrodes R1, R2, R3, R4, and R5. At this time, an electric field is generated between the pixel electrode PE and the common electrode CE due to the potential difference between the potential Vpix of the pixel electrode PE and the potential Vcom of the common electrode CE. This electric field acts on the liquid crystal layer LC.

The first substrate SUB1 comprises a switching element SW2, a sensor scanning line SGL, relay electrodes R6, R7, R8, and R9, a second power line SPL2, and a third power line SPL3 as elements related to the sensor SS. In addition, the sensor SS comprises a first electrode E1 (lower electrode), a second electrode E2 (upper electrode), and a photoelectric conversion element PC.

In FIG. 6, an element associated with the switching elements SW2A, SW2B, and SW2C related to the sensor SS is represented as switching element SW2 for convenience of description. In addition, in FIG. 6, an element that functions as the gate electrode of the switching element SW2 is represented as the sensor scanning line SGL. In FIG. 6, an element that functions as the source electrode of the switching element SW2 is represented as the relay electrode R7. In FIG. 6, an element that functions as the drain electrode of the switching element SW2 is represented as the relay electrode R6. In addition, in FIG. 6, not all of the elements related to the sensor SS, but some of them are illustrated.

The photoelectric conversion element PC has a first surface F1 opposed to the first base material 10 and a second surface F2 opposed to the liquid crystal layer LC. The second surface F2 of the photoelectric conversion element PC corresponds to the upper surface of the sensor SS. The photoelectric conversion element PC is located between the insulating layers 13 and 14. The first electrode E1 is arranged between the photoelectric conversion element PC and the insulating layer 13, and is in contact with the first surface F1. An outer peripheral portion of the first electrode E1 protrudes from the photoelectric conversion element PC and is covered with the insulating layer 14. The first electrode E1 is in contact with the relay electrode R6 through a contact hole CH9 penetrating the insulating layer 13 under the photoelectric conversion element PC. The second electrode E2 is arranged between the photoelectric conversion element PC and the insulating layer 14, and is in contact with the second surface F2. The second electrode E2 is in contact with the second power line SPL2 through a contact hole CH10 penetrating the insulating layer 14 above the photoelectric conversion element PC.

The second power line SPL2 is arranged between the insulating layers 14 and 15, and is in contact with the second electrode E2 through the contact hole CH10 penetrating the insulating layer 14. The second potential Vcom_FPS is supplied to the second power line SPL2, and the second potential Vcom_FPS is supplied to the second electrode E2 through the second power line SPL2.

The switching element SW2 includes a semiconductor layer SC2. The semiconductor layer SC2 is arranged between the first base material 10 and the insulating layer 11. The sensor scanning line SGL is arranged between the insulating layers 11 and 12, and is opposed to the semiconductor layer SC2. The sensor scanning line SGL may be arranged not between the insulating layers 11 and 12, but in the other layer.

The relay electrode R6 is arranged between the insulating layers 12 and 13, and is in contact with the semiconductor layer SC2 through a contact hole CH11 penetrating the insulating layers 11 and 12. The relay electrode R7 is arranged between the insulating layers 12 and 13, i.e., in the same layer as the relay electrode R6, and is in contact with the semiconductor layer SC2 through a contact hole CH12 penetrating the insulating layers 11 and 12. The relay electrode R8 is arranged between the insulating layers 13 and 14, i.e., in the same layer as the first electrode E1, and is in contact with the relay electrode R7 through a contact hole CH13 penetrating the insulating layer 13. The relay electrode R9 is arranged between the insulating layers 14 and 15, i.e., in the same layer as the second power line SPL2, and is in contact with the relay electrode R8 through a contact hole CH14 penetrating the insulating layer 14.

The third power line SPL3 is arranged between the insulating layers 15 and 16, i.e., in the same layer as the power line PL, and is in contact with the relay electrode R9 through a contact hole CH15 penetrating the insulating layer 15. The third potential VPP2 is supplied to the third power line SPL3. The third power line SPL3 not only supplies the third potential VPP2, but also functions as the above-described collimating layer CL1. In other words, a part of the third power line SPL3 is the above-described collimating layer CL1. The third power line SPL3 has an opening OP at a position which overlaps with the second surface F2 of the photoelectric conversion element PC.

The signal line SL and the relay electrodes R1, R6, and R7 are formed of the same metal material. The first electrode E1 and the relay electrodes R2 and R8 are formed of the same metal material. The second power line SPL2 and the relay electrodes R3 and R9 are formed of the same metal material. The power line PL, the third power line SPL3, and the relay electrode R4 are formed of the same metal material. The second electrode E2, the pixel electrode PE, the common electrode CE, and the relay electrode R5 are formed of a transparent conductive material such as indium tin oxide (ITO).

The first electrode E1 formed of a metal material also functions as a light-shielding layer and suppresses the incidence of light from below to the photoelectric conversion element PC. The photoelectric conversion element PC is, for example, a photodiode and outputs the detection signal Vdet corresponding to the incident light. A positive intrinsic negative (PIN) photodiode can be used as the photoelectric conversion element PC. This type of photodiode includes a p-type semiconductor layer, an i-type semiconductor layer, and an n-type semiconductor layer. The p-type semiconductor layer is located on the second electrode E2 side. The n-type semiconductor layer is located on the first electrode E1 side. The i-type semiconductor layer is located between the p-type semiconductor layer and the n-type semiconductor layer.

The p-type semiconductor layer, the i-type semiconductor layer, and the n-type semiconductor layer are formed of, for example, amorphous silicon (a-Si). The material of the semiconductor layers are not limited to this, but the amorphous silicon may be replaced with polycrystalline silicon, microcrystalline silicon, or the like, and the polycrystalline silicon may be replaced with amorphous silicon, microcrystalline silicon, or the like.

In addition, an organic photo diode (OPD) may be used instead of the PIN photodiode.

A scanning signal is supplied to the sensor scanning line SGL at the timing at which detection is to be performed by the sensor SS. When the scanning signal is supplied to the sensor scanning line SGL, the detection signal generated by the photoelectric conversion element PC is output to the sensor signal line SSL which is omitted in FIG. 6. The detection signal output to the sensor signal line SSL is output to the AFE-IC 1.

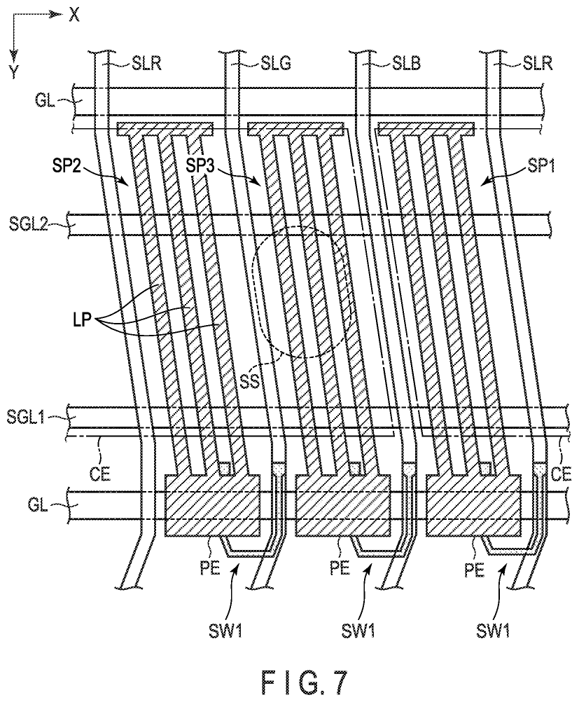

FIG. 7 is a plan view schematically showing several elements of the first substrate SUB1, illustrating the positional relationship between the sensor SS, the pixel electrode PE, and the common electrode CE.

The pixel electrodes PE of the sub-pixels SP1, SP2, and SP3 have the same shape. Each of the pixel electrodes PE is arranged in an area surrounded by two scanning lines GL aligned along the second direction Y and two signal lines SL aligned along the first direction X. Each pixel electrode PE is electrically connected to the switching element SW1 provided to correspond thereto. The first scanning line SGL1 and the second scanning line SGL2 are aligned along the second direction Y between the two scanning lines GL.

In the example of FIG. 7, the pixel electrode PE has three line portions LP extending along the second direction Y and arranged along the first direction X. The openings of the sub-pixels SP1, SP2, and SP3 overlap with the line portions LP of the sub-pixels SP1, SP2, and SP3, respectively. Each pixel electrode PE overlaps with a common electrode CE arranged in an area surrounded by a one-dot chain line, in planar view. Although omitted in FIG. 7 for convenience of description, the common electrode CE is actually located in an area other than the area surrounded by the one-dot chain line, and extends over a plurality of pixels.

As shown in FIG. 7, the pixel electrode PE and the common electrode CE are also arranged in the area, which overlaps with the sensor SS arranged in the sub-pixel SP3, in planar view. In other words, the electric field generated between the pixel electrode PE and the common electrode CE arranged in the area overlapping with the sensor SS in planar view acts on the liquid crystal molecules contained in the liquid crystal layer LC and located directly above the sensor SS, and liquid crystal molecules are driven in the same manner as the other liquid crystal molecules.

A method of adjusting the common voltage Vcom to minimize the flicker component, using the sensor SS and the sensor circuit SSC shown in FIG. 2 to FIG. 7, will be described below.

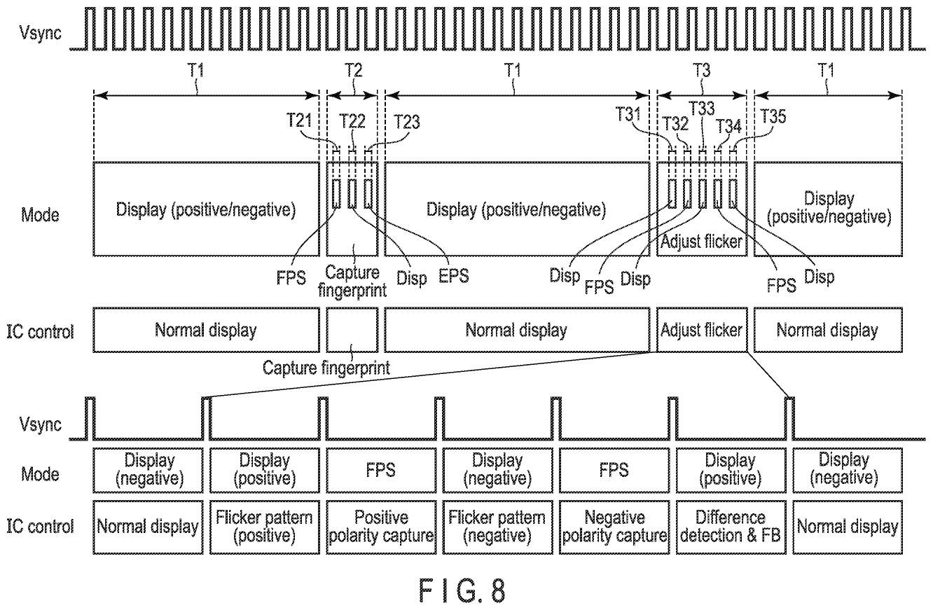

FIG. 8 is a diagram illustrating an overview of the operations of the AFE-IC 1 according to the present embodiment.

The AFE-IC 1 operates according to the synchronization signal Vsync input for each frame and performs various controls described below.

In a display period T1 for displaying images, the AFE-IC 1 performs normal display control of alternately repeating Display-positive mode and Display-negative mode on a frame-by-frame basis.

In a fingerprint capturing period T2, the AFE-IC 1 performs control for capturing a fingerprint (detecting surface unevenness of a finger). The fingerprint capturing period T2 includes a reset period T21, an exposure period T22, and a read period T23. In the reset period T21, the AFE-IC 1 operates in FPS mode. The AFE-IC 1 controls the sensor circuit SSC to reset the potential of the node N1 of the sensor circuit SSC shown in FIG. 4 to the first potential VPP1, and output the detection signal Vdet1. In addition, in the read period T23, the AFE-IC 1 also operates in the FPS mode. The AFE-IC 1 controls the sensor circuit SSC to output the detection signal Vdet2 affected by a voltage drop corresponding to the amount of light (light reflected by the finger) coming in the sensor SS during the exposure period T22. The above-described FPS mode may be referred to as a fingerprint detection mode or, simply, a detection mode.

In the exposure period T22, the AFE-IC 1 operates in either the Display-positive mode or the Display-negative mode, and the operation mode is determined based on the operation mode in the previous display period T1. For example, if the operation mode in the previous display period T1 is the Display-positive mode, the AFE-IC 1 operates in the Display-negative mode in the exposure period T22. In contrast, if the operation mode in the previous display period T1 is the Display-negative mode, the AFE-IC 1 operates in the Display-positive mode in the exposure period T22.

In the flicker adjustment period T3, the AFE-IC 1 adjusts the common voltage Vcom to minimize the flicker component. The flicker adjustment period T3 includes a first flicker pattern display period T31, a first detection period T32, a second flicker pattern display period T33, a second detection period T34, and a common voltage adjustment period T35.

In the first flicker pattern display period T31, the AFE-IC 1 operates in the Display-positive mode and controls displaying the flicker pattern based on the positive polarity pixel signal.

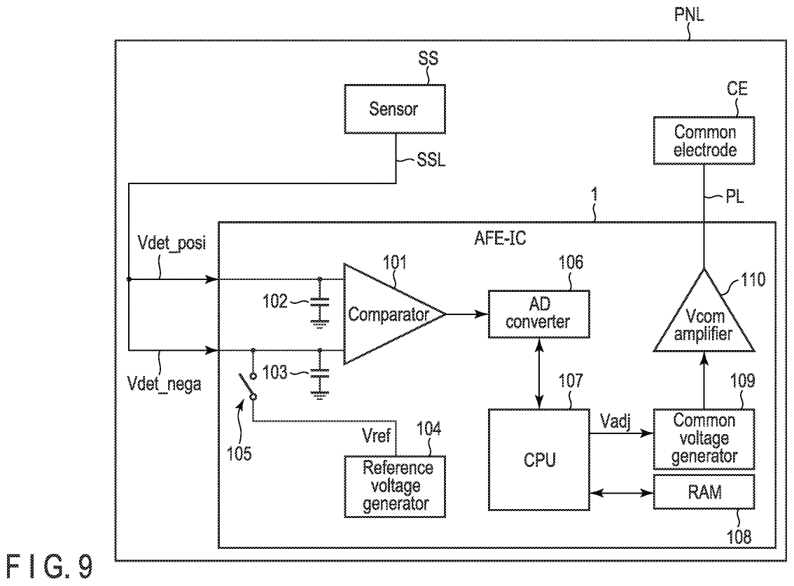

In the first detection period T32, the AFE-IC 1 operates in the FPS mode and controls to perform positive polarity capturing. More specifically, the AFE-IC 1 controls the sensor circuit SSC to output the detection signal Vdet_posi (see FIG. 9) affected by the voltage drop corresponding to the amount of light (external light) coming in the sensor SS in the first flicker pattern display period T31.

In the second flicker pattern display period T33, the AFE-IC 1 operates in the Display-negative mode and controls displaying the flicker pattern based on the negative polarity pixel signal.

In the second detection period T34, the AFE-IC 1 operates in the FPS mode and controls to perform negative polarity capturing. More specifically, the AFE-IC 1 controls the sensor circuit SSC to output the detection signal Vdetnega (see FIG. 9) affected by the voltage drop corresponding to the amount of light (external light) coming in the sensor SS in the second flicker pattern display period T33.

The operation mode of the AFE-IC 1 in the first flicker pattern display period T31 is determined based on the operation mode in the previous display period T1, similarly to the above-described operation mode in the exposure period T22. In FIG. 8, since the operation mode in the previous display period T1 is assumed to be the Display-negative mode, the operation mode of the AFE-IC 1 in the first flicker pattern display period T31 is the Display-positive mode. However, when the operation mode in the previous display period T1 is the Display-positive mode, the operation mode of the AFE-IC 1 in the first flicker pattern display period T31 is the Display-negative mode. In this case, the AFE-IC 1 controls displaying the flicker pattern based on the negative polarity pixel signal, in the first flicker pattern display period T31, and controls the sensor circuit SSC to output the detection signal Vdetnega, in the first detection period T32. Furthermore, in this case, the AFE-IC 1 controls displaying the flicker pattern based on the positive polarity pixel signal, in the second flicker pattern display period T33, and controls the sensor circuit SSC to output the detection signal Vdet_posi, in the second detection period T34.

In the common voltage adjustment period T35, the AFE-IC 1 operates in either the Display-positive mode or the Display-negative mode, and the operation mode is determined based on the operation mode in the second flicker pattern display period T33. In FIG. 8, since it is assumed that the operation mode of the AFE-IC 1 in the second flicker pattern display period T33 is the Display-negative mode, the AFE-IC 1 operates in the Display-positive mode in the common voltage adjustment period T35. The AFE-IC 1 detects the difference between the detection signal Vdet_posi and the detection signal Vdetnega, feeds back the difference to a common voltage generator, and adjusts the common voltage Vcom supplied to the common electrode CE.

FIG. 9 is a diagram showing a configuration example of the AFE-IC 1 according to the present embodiment. As shown in FIG. 9, the AFE-IC 1 comprises a comparator 101, a capacitor 102, a capacitor 103, a reference voltage generator 104, a switch 105, an AD converter 106, a central processing unit (CPU) 107, a random access memory (RAM) 108, a common voltage generator 109, and a Vcom amplifier 110.

One of two input terminals of the comparator 101 is connected to the capacitor 102. The capacitor 102 is connected to the sensor signal line SSL electrically connected to the sensor SS. The detection signal Vdet_posi output in the first detection period T32 shown in FIG. 8 is stored (charged) in the capacitor 102. In other words, the detection signal Vdet_posi which is output from the sensor SS when the display panel PNL is in the positive polarity state is stored in the capacitor 102. The detection signal Vdet_posi stored in the capacitor 102 is input (supplied) to one of the input terminals of the comparator 101.

The other of the two input terminals of the comparator 101 is connected to the capacitor 103. The capacitor 103 is connected to the sensor signal line SSL electrically connected to the sensor SS. The detection signal Vdetnega output in the second detection period T34 shown in FIG. 8 is stored (charged) in the capacitor 103. In other words, the detection signal Vdetnega which is output from the sensor SS when the display panel PNL is in the negative polarity state is stored in the capacitor 103. The detection signal Vdetnega stored in the capacitor 103 is input (supplied) to the other input terminal of the comparator 101.

The reference voltage generator 104 is connected to the other input terminal of the comparator 101 via the switch 105. However, in the configuration example, the switch 105 is turned off and the reference voltage Vref generated by the reference voltage generator 104 is not input (supplied) to the other input terminal of the comparator 101.

The output terminal of the comparator 101 is connected to the AD converter 106. The AD converter 106 converts analog data indicating a difference between the detection signal Vdet_posi and the detection signal Vdetnega which are output from the output terminal of the comparator 101 into digital data, under control of the CPU 107. The difference data indicating the difference between the detection signal Vdet_posi and the detection signal Vdetnega is stored in the RAM 108 by the CPU 107.

The CPU 107 controls the operation of each unit included in the AFE-IC 1. The CPU 107 generates a correction value Vadj of the common voltage Vcom, based on the difference data stored in the RAM 108. The CPU 107 corrects (adjusts) a Vcom value (register value) stored in a Vcom register (not shown) included in the common voltage generator 109, using the generated correction value Vadj.

The common voltage generator 109 generates the common voltage Vcom, based on the Vcom value stored in the Vcom register. The common voltage Vcom generated by the common voltage generator 109 is amplified by the Vcom amplifier 110 and supplied to the common electrode CE via the power line PL.

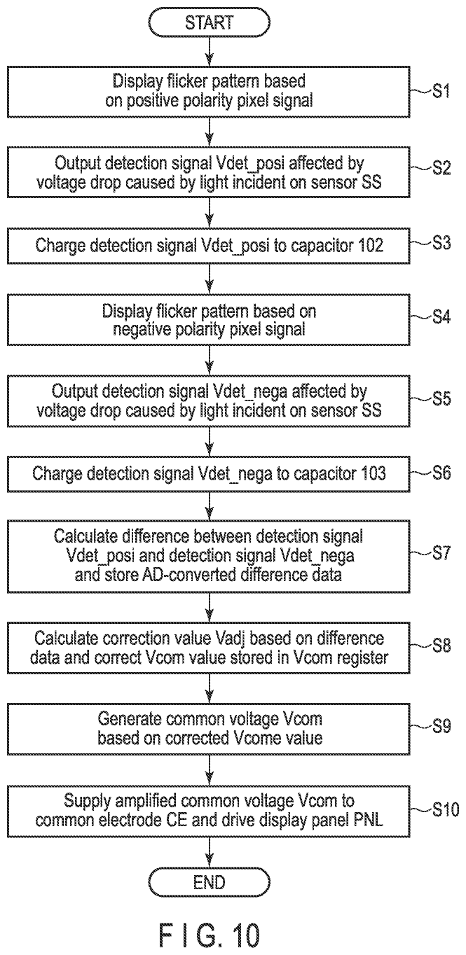

FIG. 10 is a flowchart showing a procedure example of the common voltage adjustment process realized by the configuration shown in FIG. 9. It is assumed that the operation mode of the AFE-IC 1 in the display period T1 immediately before the flicker adjustment period T3 is the Display-negative mode.

When the flicker adjustment period T3 is started, the AFE-IC 1 displays a flicker pattern based on a positive polarity pixel signal on the display panel PNL (step S1). As a result, light corresponding to the panel luminance at the time of flicker pattern display based on the positive polarity pixel signal comes in the sensor SS. The sensor circuit SSC outputs a voltage signal (detection signal Vdet_posi) affected by the voltage drop corresponding to the amount of light (external light) coming in the sensor SS (step S2).

The AFE-IC 1 charges the voltage signal (detection signal Vdet_posi) output from the sensor circuit SSC to the capacitor 102 (step S3).

Next, the AFE-IC 1 displays a flicker pattern based on the negative-polarity pixel signal on the display panel PNL (step S4). As a result, light corresponding to the panel luminance at the time of flicker pattern display based on the negative-polarity pixel signal comes in the sensor SS. The sensor circuit SSC outputs a voltage signal (detection signal Vdetnega) affected by the voltage drop corresponding to the amount of light (external light) coming in the sensor SS (step S5).

The AFE-IC 1 charges the voltage signal (detection signal Vdetnega) output from the sensor circuit SSC to the capacitor 103 (step S6).

The voltage signal (detection signal Vdet_posi) charged to the capacitor 102 and the voltage signal (detection signal Vdetnega) charged to the capacitor 103 are input (supplied) to the input terminal of the comparator 101, under control of the CPU 107. The CPU 107 controls the comparator 101 to calculate the difference between the input detection signal Vdet_posi and the input detection signal Vdetnega. The CPU 107 controls the AD converter 106 to convert the analog data indicating the difference between the detection signal Vdet_posi and the detection signal Vdetnega which are output from the output terminal of the comparator 101 into digital data. The CPU 107 stores the converted data in the RAM 108 (step S7). According to this, the difference data indicating the difference between the detection signal Vdet_posi and the detection signal Vdetnega is stored in the RAM 108.

The CPU 107 calculates the correction value Vadj to minimize the flicker component, based on the difference data stored in the RAM 108. The CPU 107 corrects the Vcom value stored in the Vcom register included in the common voltage generator 109, based on the correction value Vadj (step S8).

The common voltage generator 109 generates the common voltage Vcom, based on the corrected Vcom value stored in the Vcom register, in frames following the processing of step S8 (step S9). The generated common voltage Vcom is amplified by the Vcom amplifier 110 and supplied to the common electrode CE via the power line PL (step S10). According to this, the display panel PNL can be driven by the adjusted common voltage Vcom.

According to the series of common voltage adjustment processes described above, it is possible to adjust the common voltage Vcom such that the flicker component is minimized and to optimize the common voltage Vcom, using the sensor SS and the sensor circuit SSC. Since the common voltage Vcom is adjusted using the sensor SS and the sensor circuit SSC which are used for the fingerprint detection, the common voltage Vcom does not need to be adjusted using a flicker meter or the like at the assembly of the display device. Therefore, the work costs and the tact loss can be suppressed.

In addition, since the series of common voltage adjustment process described above can complete the process inside the AFE-IC 1, the common voltage Vcom can be automatically optimized without the need for external operation, by only providing the dedicated AFE-IC 1. Furthermore, according to the series of common voltage adjustment processes described above, the common voltage Vcom can be optimized at any timing after the display device is assembled. Therefore, it is possible to deal with the flicker which occurs subsequently.

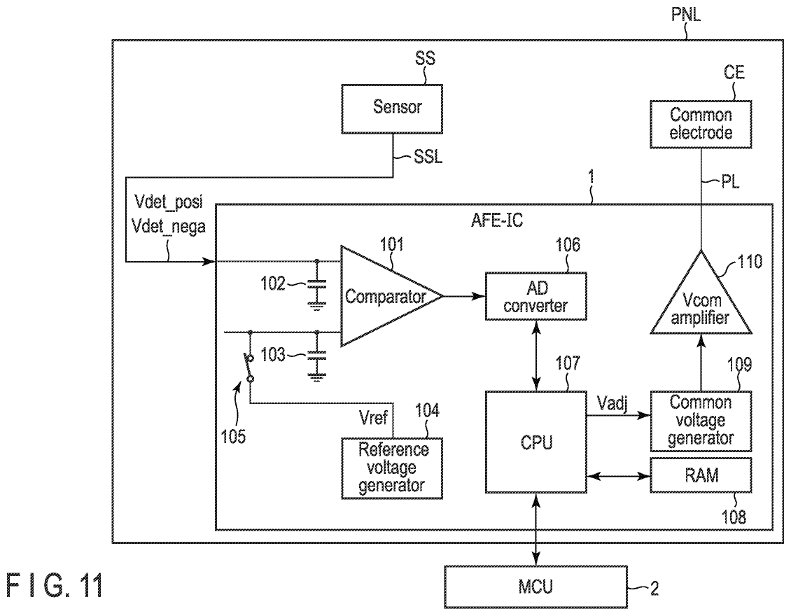

FIG. 11 is a diagram showing a configuration example of the AFE-IC 1 according to the present embodiment, illustrating a configuration different from the configuration shown in FIG. 9. As shown in FIG. 11, the AFE-IC 1 comprises the comparator 101, the capacitor 102, the capacitor 103, the reference voltage generator 104, the switch 105, the AD converter 106, the CPU 107, the RAM 108, the common voltage generator 109, and the Vcom amplifier 110, and the elements provided in the AFE-IC 1 are the same as those shown in FIG. 9. However, the configuration shown in FIG. 11 is different from that shown in FIG. 9 in that the sensor signal line SSL is connected to only one of input terminals of the comparator 101 and that the reference voltage generator 104 is connected to the other input terminal of the comparator 101 via the switch 105. In addition, the configuration shown in FIG. 11 is different from that shown in FIG. 9 in that the AFE-IC 1 is controlled by the MCU 2. Parts different from the configuration shown in FIG. 9 will be mainly described below, and descriptions on the same parts as the configuration shown in FIG. 9 will be omitted.

One of two input terminals of the comparator 101 is connected to the capacitor 102. The capacitor 102 is connected to the sensor signal line SSL electrically connected to the sensor SS. The detection signal Vdet_posi output in the first detection period T32 shown in FIG. 8 and the detection signal Vdetnega output in the second detection period T34 shown in FIG. 8 are sequentially stored (charged) in the capacitor 102 at different timing.

The other of the two input terminals of the comparator 101 is connected to the reference voltage generator 104 via the switch 105.

The AD converter 106 converts analog data indicating a difference between the detection signal Vdetposi output from the output terminal of the comparator 101 and the reference voltage Vref into digital data, under control of the CPU 107. A first difference data indicating the difference between the detection signal Vdet_posi and the reference voltage Vref is stored in the RAM 108 by the CPU 107. In addition, the AD converter 106 converts analog data indicating a difference between the detection signal Vdetnega output from the output terminal of the comparator 101 and the reference voltage Vref into digital data, under control of the CPU 107. A second difference data indicating the difference between the detection signal Vdetnega and the reference voltage Vref is stored in the RAM 108 by the CPU 107.

The CPU 107 reads the first difference data and the second difference data which are stored in the RAM 108 and transmits the data to the MCU 2. When receiving the correction data indicating the correction value Vadj transmitted from the MCU 2, the CPU 107 corrects the Vcom value (register value) stored in a Vcom register (not shown) included in the common voltage generator 109, using the correction value Vadj indicated by the correction data.

When receiving the first difference data and the second difference data transmitted from the CPU 107 of the AFE-IC 1, the MCU 2 calculates the correction value Vadj of the common voltage Vcom, based on the first difference data and the second difference data. The correction data indicating the calculated correction value Vadj is transmitted to the CPU 107 of the AFE-IC 1.

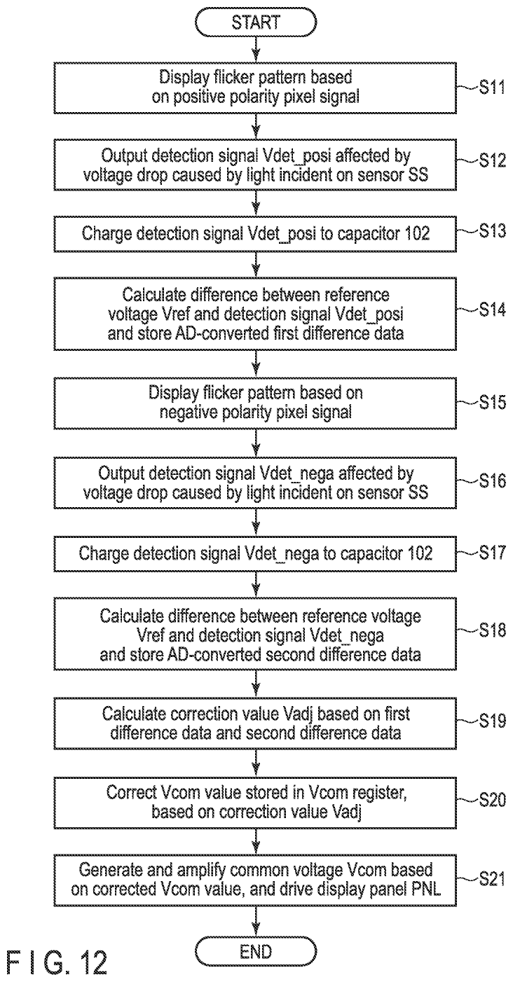

FIG. 12 is a flowchart showing a procedure example of the common voltage adjustment process realized by the configuration shown in FIG. 11. It is assumed that the operation mode of the AFE-IC 1 in the display period T1 immediately before the flicker adjustment period T3 is the Display-negative mode.

When the flicker adjustment period T3 is started, the AFE-IC 1 displays a flicker pattern based on a positive polarity pixel signal on the display panel PNL (step S11). As a result, light corresponding to the panel luminance at the time of flicker pattern display based on the positive polarity pixel signal comes in the sensor SS. The sensor circuit SSC outputs a voltage signal (detection signal Vdet_posi) affected by the voltage drop corresponding to the amount of light (external light) coming in the sensor SS (step S12).

The AFE-IC 1 charges the voltage signal (detection signal Vdet_posi) output from the sensor circuit SSC to the capacitor 102 (step S13).

The voltage signal (detection signal Vdet_posi) charged to the capacitor 102 and the reference voltage Vref generated by the reference voltage generator 104 are input (supplied) to the input terminal of the comparator 101, under control of the CPU 107. The CPU 107 controls the comparator 101 to calculate the difference between the input detection signal Vdet_posi and the reference voltage Vref. The CPU 107 controls the AD converter 106 to convert the analog data indicating the difference between the detection signal Vdet_posi output from the output terminal of the comparator 101 and the reference voltage Vref into digital data. The CPU 107 stores the converted data in the RAM 108 (step S14). According to this, the first difference data indicating the difference between the detection signal Vdetposi and the reference voltage Vref is stored in the RAM 108.

Next, the AFE-IC 1 displays a flicker pattern based on the negative-polarity pixel signal on the display panel PNL (step S15). According to this, light corresponding to the panel luminance at the time of flicker pattern display based on the negative-polarity pixel signal comes in the sensor SS. The sensor circuit SSC outputs a voltage signal (detection signal Vdetnega) affected by the voltage drop corresponding to the amount of light (external light) coming in the sensor SS (step S16).

The AFE-IC 1 charges the voltage signal (detection signal Vdetnega) output from the sensor circuit SSC to the capacitor 102 (step S17).

The voltage signal (detection signal Vdetnega) charged to the capacitor 102 and the reference voltage Vref generated by the reference voltage generator 104 are input (supplied) to the input terminal of the comparator 101, under control of the CPU 107. The CPU 107 controls the comparator 101 to calculate the difference between the input detection signal Vdetnega and the reference voltage Vref. The CPU 107 controls the AD converter 106 to convert the analog data indicating the difference between the detection signal Vdetnega output from the output terminal of the comparator 101 and the reference voltage Vref into digital data. The CPU 107 stores the converted data in the RAM 108 (step S18). According to this, the second difference data indicating the difference between the detection signal Vdetnega and the reference voltage Vref is stored in RAM 108.

The CPU 107 reads the first difference data and the second difference data which are stored in the RAM 108 and transmits the data to the MCU 2. When receiving the first difference data and the second difference data which are transmitted from the CPU 107 of the AFE-IC 1, the MCU 2 calculates the correction value Vadj to minimize the flicker component, based on the first difference data and the second difference data (step S19). The correction data indicating the calculated correction value Vadj is transmitted from the MCU 2 to the AFE-IC 1.

When receiving the correction data transmitted from the MCU 2, the CPU 107 of the AFE-IC 1 corrects (adjusts) the Vcom value stored in the Vcom register included in the common voltage generator 109, based on the correction value Vadj indicated by the correction data (step S20).

The common voltage generator 109 generates the common voltage Vcom, based on the corrected Vcom value stored in the Vcom register, in frames following the processing of step S20. The generated common voltage Vcom is amplified by the Vcom amplifier 110 and supplied to the common electrode CE via the power line PL (step S21). According to this, the display panel PNL can be driven by the adjusted common voltage Vcom.

According to the series of common voltage adjustment processes described above, it is possible to adjust the common voltage Vcom such that the flicker component is minimized and to optimize the common voltage Vcom, using the sensor SS and the sensor circuit SSC, similarly to the common voltage adjustment process shown in FIG. 10. In this case, too, since the common voltage Vcom is adjusted using the sensor SS and the sensor circuit SSC which are used for the fingerprint detection, the common voltage Vcom does not need to be adjusted using a flicker meter or the like at the assembly of the display device. Therefore, the work costs and the tact loss can be suppressed.

In addition, in the series of common voltage adjustment processes described above, optimization of the common voltage Vcom can be achieved using a general-purpose AFE-IC 1 since the MCU 2 calculates the correction value Vadj of the common voltage Vcom. Furthermore, according to the series of common voltage adjustment processes described above, it is possible to deal with the flicker that occurs subsequently since the common voltage Vcom can be optimized at any timing after the display device is assembled, similarly to the common voltage adjustment process shown in FIG. 10.

In the present embodiment, it is assumed that the display panel PNL is driven in the frame-inversion drive scheme and that the potential Vcom of the common electrode CE is constant (i.e., in the common DC scheme). However, the common voltage adjustment process of the present embodiment can also be used when the display panel PNL is driven in the frame-inversion drive scheme and the polarity of the common electrode C E is inverted in each frame (i.e., in the common inversion scheme).

In addition, in the present embodiment, adjusting the common voltage Vcom using one sensor SS and one sensor circuit SSC has been described, but the common voltage Vcom may be adjusted using a plurality of sensors SS and sensor circuits SSC. For example, the above-described correction value Vadj may be calculated for each of the plurality of sensors SS, and the above-described Vcom value may be corrected based on an average of the correction values Vadj.

Alternatively, a plurality of sets of first detection signals Vdet_posi and second detection signals Vdetnega may be obtained from one sensor SS, the above-described correction value Vadj may be calculated for each of the sets, and the above-described Vcom value may be corrected based on an average of the correction values Vadj.

In the present embodiment, the display device DSP is the liquid crystal display device comprising the illumination device IL. However, the display device DSP is not limited to this and may be an organic electroluminescent display device comprising an organic light emitting diode (OLED) as a display element.

According to the embodiment described above, the display device DSP capable of suppressing the flicker can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel comprising a first substrate, a second substrate opposed to the first substrate, and a liquid crystal layer located between the first substrate and the second substrate; and
a processing unit mounted on the display panel,
the first substrate comprising:
a plurality of pixel electrodes;
a plurality of switching elements provided to correspond to the plurality of pixel electrodes, respectively;
a common electrode opposed to the plurality of pixel electrodes; and
an optical sensor outputting a detection signal corresponding to an amount of light coming from the liquid crystal layer side,
the processing unit adjusting a common voltage supplied to the common electrode, based on a first detection signal output from the optical sensor when the display panel is in a positive polarity state, and a second detection signal output from the optical sensor when the display panel is in a negative polarity state.

2. The display device of claim 1, wherein
the processing unit:
displays a first pattern based on a positive polarity pixel signal on the display panel,
receives input of the first detection signal output from the optical sensor corresponding to the amount of light when the first pattern is displayed,
displays a second pattern based on a negative polarity pixel signal on the display panel, at timing different from the timing of displaying the first pattern, and
receives input of the second detection signal output from the optical sensor corresponding to the amount of light when the second pattern is displayed.

3. The display device of claim 1, wherein
the first detection signal is a voltage signal affected by voltage drop corresponding to the amount of light coming in the optical sensor when the display panel is in the positive polarity state, and
the second detection signal is a voltage signal affected by voltage drop corresponding to the amount of light coming in the optical sensor when the display panel is in the negative polarity state.

4. The display device of claim 1, wherein
the processing unit comprises:
a common voltage generator generating the common voltage based on a register value stored in a register;
a comparator including a first terminal to which the first detection signal is input and a second terminal to which the second detection signal is input; and
a processor calculating a correction value for correcting the register value based on a difference between the first detection signal and the second detection signal which are output from the comparator, and correcting the register value based on the correction value, and
the common voltage generator generates the common voltage based on the corrected register value stored in the register and supplies the common voltage to the common electrode.

5. The display device of claim 1, further comprising:
a controller connected to the processing unit, wherein
the processing unit comprises:
a common voltage generator generating the common voltage based on a register value stored in a register;
a reference voltage generator generating a reference voltage;
a comparator including a first terminal to which the first detection signal and the second detection signal are input at timing different from each other, and a second terminal to which the reference voltage is input; and
a processor generates first difference data indicating a difference between first detection signal output from the comparator and the reference voltage, and second difference data indicating a difference between the second detection signal output from the comparator and the reference voltage, and transmits the first difference data and the second difference data to the controller, and
when receiving the first difference data and the second difference data which are transmitted from the processor, the controller calculates the correction value for correcting the register value, based on the first difference data and the second difference data, and transmits correction data indicating the correction value to the processor.

6. The display device of claim 5, wherein
when receiving the correction data transmitted from the controller, the processor corrects the register value based on the correction value indicated by the correction data, and
the common voltage generator generates the common voltage based on the corrected register value stored in the register and supplies the common voltage to the common electrode.

7. The display device of claim 1, wherein
the optical sensor overlaps with one of the plurality of pixel electrodes and the common electrode in planar view.

8. The display device of claim 1, wherein
the plurality of pixel electrodes and the common electrode are formed of a transparent conductive material.

9. The display device of claim 1, wherein
the optical sensor comprises:
a photoelectric conversion element;
a first electrode arranged under the photoelectric conversion element and formed of a metal material; and
a second electrode arranged on the photoelectric conversion element and formed of a transparent metal material.
